(19) United States
(12) Patent Application Publication
(10) Pub. No.: US 2015/0137524 A1
(43) Pub. Date: May 21, 2015

(54) ELECTRIC GENERATOR

(71) Applicant: Antonio Garcia Carvajal, Granada (ES)

(72) Inventor: Antonio Garcia Carvajal, Granada (ES)

(21) Appl. No.: 14/403,266

(22) PCT Filed: Feb. 15, 2013
(86) PCT No.: PCT/ES2013/000038

§ 371 Date: Jan. 30, 2015

(30) Foreign Application Priority Data
May 25, 2012 (ES) P 201200562

(51) Int. Cl. H02K 7/18

(52) U.S. Cl. CPC H02K 7/1807; Y10S 74/09; H02K 53/00
USPC 290/1 A; 74/DIG. 9

(57) ABSTRACT

Electric generator comprising a plurality of symmetrical articulated arms that act as a lever on plunger/piston assemblies to pressurize a fluid used to drive a turbine.

### OBJECT OF THE INVENTION

The invention, as expressed in the title, relates to an assembly for generating electricity, which provides, as regards the function to which it is devised, several novel advantages and features which will be described below in greater detail, and which constitute an improvement against all systems currently known in the state of the art for the same purpose.

More particularly, the object of the invention is based on an assembly intended to generate electricity and comprising an electric motor which actuates a machine having articulated arms acting as a lever for multiplying the force received towards some cylinders pressurizing a fluid, which fluid on tour is used for impelling turbine which makes an electric generator rotate, the electric motor being able to be connected to such generator for powering thereof, after initial start of the assembly.

### FIELD OF THE INVENTION

The field of the invention of the present invention is based in the energy sector, more particularly in the devices, machines and apparatuses devised for electricity production.

### BACKGROUND OF THE INVENTION

As it is known, the production of electricity in the world currently causes serious problems such as:
Economic problems, due to it high price.
Environmental problems—pollution of the atmosphere, rivers, seas etc.
High risks relating to nuclear energy.
Continual increase in demand, etc.

It would therefore be desirable to find a solution to these problems that is, durable, clean, economic and abundant, the object of the present invention being the development of a machine which, coupled to a set of elements, provides such a solution in an effective way.

As a reference to the state of the art, it must be noticed that, although various documents are known describing different types of systems for generating electricity, none of them presents technical or constructive features which are similar to those of the generating assembly claimed in the present invention.

Document GR 1004498 describes a machine of the type of that of the present invention, wherein although it is based in several devices in a diamond shape and comprising articulated arms, relates to a system of multiplying energy which is highly different to that of the present invention, basically as it is more complex than that of the present invention.

### DESCRIPTION OF THE INVENTION

The present invention relates to an assembly for generating electricity which essentially comprises: an electric motor; a machine having articulated arms, which is actuated by the electric motor; and a turbine which, impelled by the multiplying action of the machine, acts on an electric generator, the generator being devised for use the electricity provided by the electric motor, and supply the output energy for a convenient use, and wherein the machine constitutes the novel element of the invention.

Thus, the machine has a structural configuration based on two essential principles: the lever law, and equally and opposite concurring forces. To that purpose, the machine comprises, at least, two groups of articulated arms, each group being symmetrically arranged with respect to the other group.

Each group consists of two portions which are consecutively articulated with respect to each other, wherein: a shorter rod portion, acts as a rod and is articulately coupled to a crankshaft, more particularly to one of the crankpins of the crankshaft, wherein the crankshaft rotates under impulse of a pulley which is linked by means of a belt, to another pulley linked to the rotating axis of the electric motor which is on the lower part of the machine; and a intermediate lever portion, which is longer, as well as is connected near the end to the rod portion, and actuates as a rod, the rod portion being joined at a point near the opposite end to a support axis acting as a fulcrum, and parallel to the axis of the crankshaft.

Furthermore, the final end of the lever portion, on the upper part of the machine, is coupled, by an interposed final segment joined to respective articulations, the piston of a cylinder which, provided with inlet and outlet valves, is connected to a fluid system.

Therefore, the lever portions of each pair of groups of arms act as levers, the fulcrum for such levers being the axis on which they can rotate and, furthermore, having an ongoing to-and-fro movement on the joint to the rod portion wherefrom they take the force.

All groups of articulated arms are identical and are symmetrically arranged, so that the value of the resulting force originated from the lever portions and the rod portions on the crankshaft is zero, so that the machine needs a minimum of energy for operation, and consequently, provides maximum yield.

The operation of the assembly is described in detail below.

The electric motor rotates a first pulley and the first pulley, through a belt, transmits the movement to a second pulley which on tour rotates the crankshaft. The crankshaft transmits a circular movement to the articulations joining it to the rod portions, and said rod portions, through the articulations joining them to the lever portions, transmit an ongoing to-and-fro movement. The articulations between lever and rod portions never trespass from one side to the other of the symmetry axis of the groups of arms, because the rod portions are longer than the lever portions.

The to-and-fro movement acquired by the lever portions of the articulated arms is transmitted to their upper ends, above the support axis, with a force which is multiplied as a result of the lever effect by which they actuate.

The forces received by the articulations of said upper ends of the lever portions will be related to the length existing from the articulations with the rods to the fulcrum.

Through the final segments, and the articulated joints thereof with the lever portions and the pistons, a to-and-fro movement is transmitted to the pistons.

Then, the pistons, provide a great push to the fluid (water or air inside the cylinders).

In the cylinders, the outlet valves are narrower that the inlet valves, so that the fluid will exist at a higher pressure. Furthermore, preferably, it is devised the existence of an additional valve on the cylinders, for extracting air which accidentally may enter the cylinders if the fluid is water.

The jets of fluid exiting the cylinder are directed to a turbine, which on tour will rotate a powerful electric generator.

Preferably, the machine has more pairs of articulated arms which are equal to those described, and having identical operation, which comprise, symmetrical pairs joint to each other at the crankshaft and the support axis, in such a fashion that they operate synchronously, therefore the jets of fluid will impact continuously the turbine, thereby producing the ongoing movement of the turbine.

The output energy from the generator may be used for other purposes.

If the fluid is water, the deposit thereof shall be preferably at a higher height than the cylinders for avoiding accidental entering of air therein.

Also preferably, the water falling from the turbine is collected in a deposit and therefrom is directed to the water deposit for feeding the cylinders, so that the water is reusable.

On the other side, if the fluid is air, a deposit is devised for collecting the air and, when it reaches an adequate pressure, using the air for impelling the turbine.

As a result of the description above, the simplicity of the force-multiplying machine of the assembly of the invention is highlighted, as it is mainly of rigid portions adapted on their ends for rotating on respective axis.

The above described assembly for generating electricity shows a novel structure made of novel structural features which are unknown up to now for that purpose, which together with its practical utility, provide enough basis for obtaining the privilege of a patent.

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1.—Shows a schematic diagram of the assembly for generating electricity of the present invention, wherein the main elements may be observed.

FIG. 2.—Shows a elevation front view of an embodiment of the machine of articulated arms of the present invention, wherein the main parts may be observed, as well as the arrangement thereof.

FIG. 3.—Shows a plan view of the machine represented in FIG. 2.

FIGS. 4.—Shows a elevation side view according to the embodiment shown on FIGS. 2 and 3.

FIGS. 5.—Shows an elevation front view of an embodiment of the crankshaft.

### PREFERRED EMBODIMENT OF THE INVENTION

In the light of the above referred figures, and according to the numeration used therein, they show a preferred embodiment of assembly for generating electricity according to the present invention, wherein the main elements and parts are described in greater detail below.

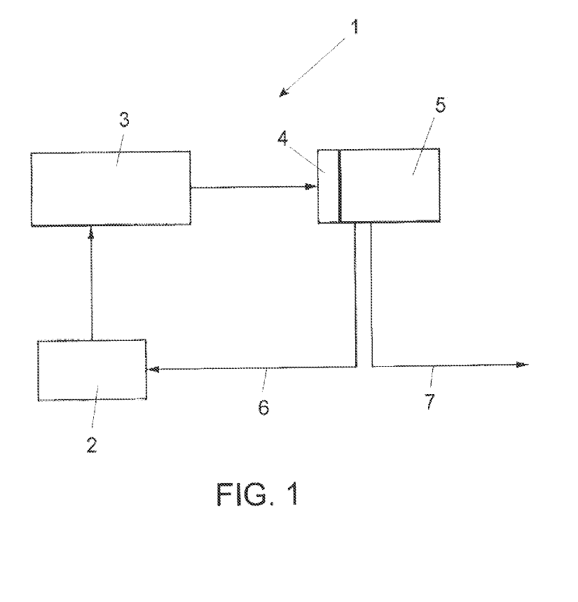

As shown in FIG. 1, the assembly (1) is configured essentially on the basis of electric motor (2) a machine (3) having articulated arms, actuated by the motor (2), and a turbine (4), impelled by the action of the machine (3), and which acts on an electric generator (5), which has a connection (6) to the motor (2), for powering thereof, and means (7) for distributing the output energy.

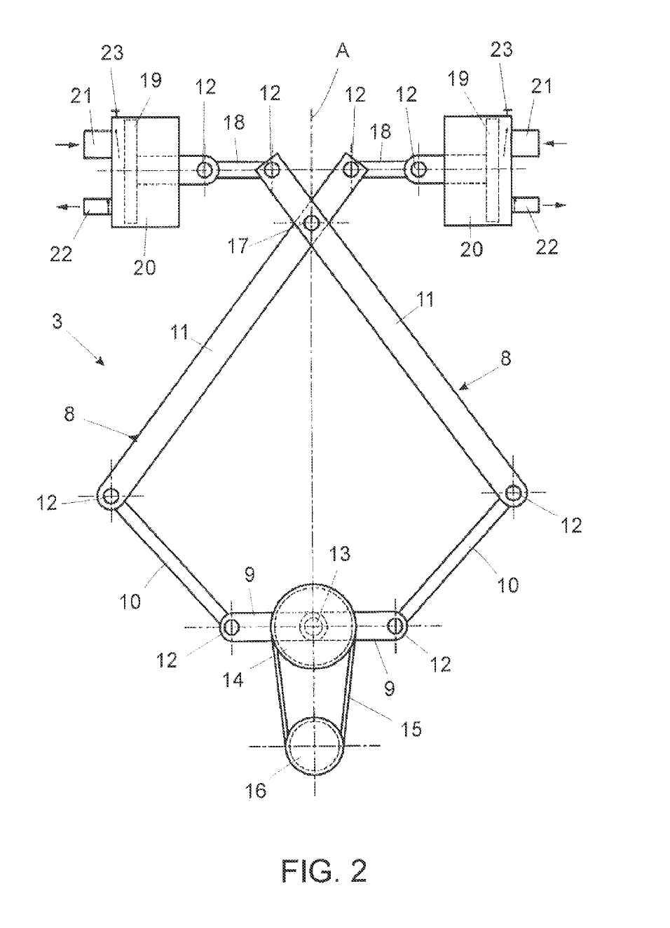

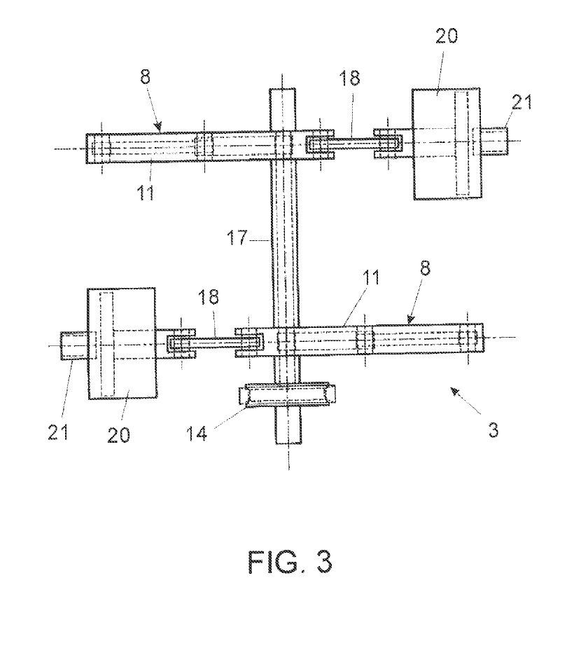

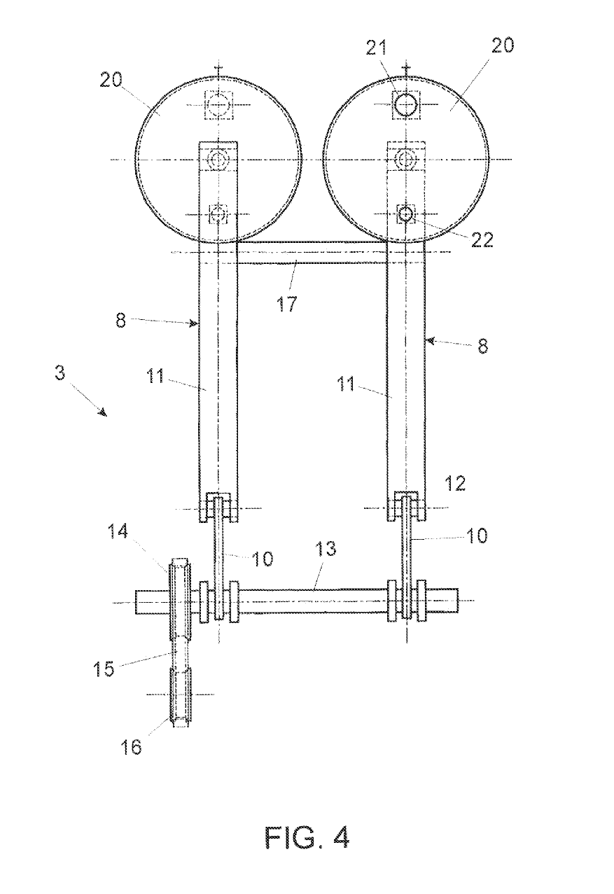

According to FIGS. 2-5, the machine (3) comprises, at least, two identical groups of articulated arms (8), which are symmetrically arranged on the basis of a vertical symmetry axis (A).

Each group of arms (8) has two portions (10, 11) consecutively joint with respect to each other through articulations (12), the portions (10, 11) consisting of: a rod portion (10) which is longer than the crankpins (9) of the crankshaft (13), to which it is articulately coupled, and wherein the crankshaft (13) rotates impelled by a first pulley (14) linked, through a belt (15), to a second pulley (16) linked to the electric motor (2); and a lever portion (11) which is joined, in a point closer to the opposite end, to a support axis (17) around which it rotates.

It is important to highlight that the joints (12) for joining the rod (10) and the lever (11) portions of each group of arms (8) never trespass from one side to the other side of the symmetry axis (A), since the rod portions (10) are longer than the crankpins (9) of the crankshaft (13) to which they are articulately joined, synchronously rotating therewith.

As a result, the lever portions (11) of each group or arms (8) act as levers, the fulcrum thereof being the support axis (17) around which they are rotatable and, furthermore, they have a ongoing to-and-fro movement at their joint (12) joining them to the rod portion (10), wherefrom they take the force.

Furthermore, the final end of the lever portion (11), at the upper part of the machine, is coupled by an interposed final segment (18) also joined at its ends through joints (12), to the piston (19) of a cylinder (20) in which an inlet valve (21) and an outlet valve (22) are provided, of lower size that the inlet valve (21), connected to a water or air fluid system, as well as, optionally, an additional valve (23) for eventually expulsing air.

As a resume, the machine (3) having articulated arms (8) multiplies received force toward the cylinders (20), pressurizing a fluid, for the purpose of which it is provided with at least two identical and symmetrical groups of articulated arms (8), at each side of the symmetry axis (A), and which move synchronously, and are joint at two points: the crankshaft (13) to which they are articulately joined at an end; and the support axis (17) acting as fulcrum since both ends of the lever portions (11) rotate around the support axis (17). At the same time, the lever portions (11) act the pistons (19) of the cylinders (20), pressurizing the fluid which impels the turbine (4).

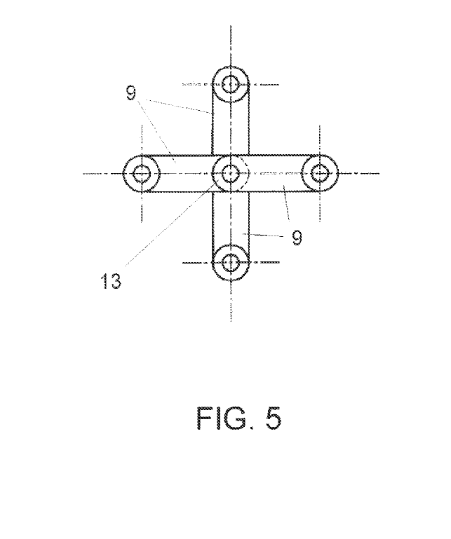

The machine has optionally more than two groups of articulated arms (8) like those described above, and joined to each other at the crankshaft (13) and at the support axis (17), the arms (8) being arranged in symmetrical pairs such as to synchronously operating, and each pair being fixed to the crankshaft (13) at respective rod portions (10). FIG. 5 shows a crankshaft (13) having crankpins (9) in the shape of a cross for illustrating such option.

1. (canceled)

2. (canceled)

3. (canceled)

4. (canceled)

5. An assembly for generating electricity, the assembly comprising:
an electric motor;
an articulated-arm machine, connected to the electric motor for being actuated by the electric motor, so as to multiply the force received from the electric motor;
a turbine, connected to the machine, so as to be impelled by the machine;
an electric generator connected to the turbine so as to be actuated by the turbine, the generator having a connection to the electric motor so as to be powered from the electric motor, for producing output energy; and
means for distributing the output energy from the generator;
wherein the machine further comprises:
at least one pair of identical, synchronously moving, articulated arms, the arms being symmetrically arranged at either side of a symmetry axis, the arms having a first end and a second end opposite the first end;
a crankshaft, having crankpins articulately joined to the first end of the arms, the crankshaft being rotatable by the electric motor;
a support axis connected to an intermediate point of the arms for acting as fulcrum for the arms, so that the second end of each respective arm is rotatable around the support axis; and
cylinders, having pistons connected to the second end of the arms, so as to be impelled by the arms, for pressurizing a fluid for impelling the turbine.

6. The assembly of claim 5, wherein each arm consists of:
a rod portion, comprising the first end of the arm; and
a lever portion, comprising the second end and the intermediate point of the arm, wherein the lever portion is articulately joined to the rod portion by means of a joint, wherefrom the lever portion is actuated, for having an ongoing to-and-fro movement.

7. The assembly of claim 5, wherein the machine further comprises:
a first pulley for rotatory impelling the crankshaft;
a second pulley connected to the electric motor; and
a belt for linking the first pulley to the second pulley.

8. The assembly of claim 6, wherein the rod portions are longer than the crankpins, as well as the rod portions are articulately joined to the crankshaft and synchronously rotating therewith, such that the joint joining the rod portions and the lever portions of each arm never trespass from one side to the opposite side of the symmetry axis.

9. The assembly of claim 5, wherein the machine further comprises:
an inlet valve and an outlet valve, both the inlet valve and the outlet valve being located on the cylinder and connected to a water or air system of fluid; and
a final segment interposed between the second end of the arm and the piston, for coupling the piston to the second end of the arm.

10. The assembly of claim 9, wherein the outlet valves are narrower than the inlet valves.

11. The assembly of claim 9, wherein, when the fluid is water, each cylinder has an additional valve for eventually expulsing air out of the cylinder.

12. The assembly of claim 9, wherein, when the fluid is water, a deposit for the water is located at a higher height than the cylinders.

13. The assembly of claim 5, wherein the machine has more than one synchronously operative pair of articulated arms.

14. The assembly of claim 6, wherein the machine further comprises:
a first pulley for rotatory impelling the crankshaft;
a second pulley connected to the electric motor; and
a belt for linking the first pulley to the second pulley.

15. The assembly of claim 7, wherein the rod portions are longer than the crankpins, as well as the rod portions are articulately joined to the crankshaft and synchronously rotating therewith, such that the joint joining the rod portions and the lever portions of each arm never trespass from one side to the other of the symmetry axis.

16. The assembly of claim 14, wherein the rod portions are longer than the crankpins, as well as the rod portions are articulately joined to the crankshaft and synchronously rotating therewith, such that the joint joining the rod portions and the lever portions of each arm never trespass from one side to the other of the symmetry axis.

17. The assembly of claim 10, wherein, when the fluid is water, each cylinder has an additional valve for eventually expulsing air out of the cylinder.

18. The assembly of claim 10, wherein, when the fluid is water, a deposit for the water is located at a higher height than the cylinders.

19. The assembly of claim 11, wherein, when the fluid is water, a deposit for the water is located at a higher height than the cylinders.

20. The assembly of claim 17, wherein, when the fluid is water, a deposit for the water is located at a higher height than the cylinders.
